(19) United States
(12) Patent Application Publication
(10) Pub. No.: US 2013/0083047 A1
(43) Pub. Date: Apr. 4, 2013

(54) SYSTEM AND METHOD FOR BUFFERING A VIDEO SIGNAL

(71) Applicants: Prashant SHAMARAO, Duluth, GA (US); Rohit Singhal, Alpharetta, GA (US)

(72) Inventors: Prashant SHAMARAO, Duluth, GA (US); Rohit Singhal, Alpharetta, GA (US)

(21) Appl. No.: 13/248,996

(22) Filed: Sep. 29, 2011

(51) Int. Cl. G09G 5/36

(52) U.S. Cl. 345/547

(57) ABSTRACT

A system for buffering a video signal is provided. The system includes a graphics processing unit (GPU), the GPU generating the video signal, and a buffering circuit coupled to the GPU, the buffering circuit receiving and temporarily storing the video signal when the GPU enters a power saving mode. The system also includes a display device coupled to the bridge circuit and receiving the video signal from the buffering circuit. The buffering circuit includes an internal memory device configured to temporarily store a first portion of the video signal, and an external memory device configured to temporarily store a second portion of the video signal. A circuit and method for buffering a video signal are also provided.

### BACKGROUND

1. Technical Field

The present disclosure is related to systems and methods for buffering a signal. In particular, the present disclosure is related to a system and method of splitting a video signal and storing the split signal in multiple memories to allow a graphics processing unit to enter a sleep mode between frame updates and conserve power.

2. Discussion of Related Art

Modern display devices are a necessity to viewing content and information produced by processing devices and content providers. As such display devices proliferate amongst users, the need to provide differing capabilities to meet the varying demands of users also is important. However, the variety in capabilities and requirements of the display devices provides a challenge to system integrators, who need to produce interfaces and connections that can seamlessly integrate across the variety of display devices.

Modern display devices receive video signals including many frames that are displayed onto a screen to display a moving image. The frames are required to be rendered at a specific pixel position in order to display the correct image. However, most frames decay almost as soon as they as they are rendered and, thus, need to be frequently refreshed in order to maintain the image display. Refreshing the image requires input from numerous components across a system, and can be a significant source of power consumption. And, as display devices are increasingly found in mobile devices powered by batteries, reducing power consumption during image refreshes is one way in which to reduce overall device power consumption.

What is needed is a system and method for decreasing the power consumption of display devices that can be used on display devices having differing display requirements.

### SUMMARY

Consistent with some embodiments there is provided a circuit for buffering a video signal. The circuit includes circuitry for receiving the video signal for output to a display device, a first memory device for receiving a first portion of the video signal, and a second memory device for receiving a second portion of the video signal, wherein the first portion and the second portion are determined by requirements of the display device.

Consistent with some embodiments, there is also provided a system for buffering a video signal. The system includes a graphics processing unit (GPU), the GPU generating the video signal, a buffering circuit coupled to the GPU, the buffering circuit receiving and temporarily storing the video signal when the GPU enters a power saving mode, and a display device coupled to the bridge circuit and receiving the video signal from the buffering circuit. The buffering circuit includes an internal memory device configured to temporarily store a first portion of the video signal, and an external memory device configured to temporarily store a second portion of the video signal.

Further consistent with some embodiments, there is also provided a method for buffering a video signal generated by a graphics processing unit (GPU) for output to a display device. The method includes the steps of determining requirements of the display device, and selectively storing portions of the video signal in a first memory device and a second memory device based on the determined requirements.

These and other embodiments will be described in further detail below with respect to the following figures.

### BRIEF DESCRIPTION OF THE DRAWINGS

FIG. 1 is a diagram illustrating a display system, consistent with some embodiments.

FIG. 2 is a diagram illustrating a display system having a bridge circuit, consistent with some embodiments.

FIG. 3 is a flowchart illustrating a method for buffering a video signal generated by a graphics processing unit (GPU) for output to a display device, consistent with some embodiments.

FIG. 4 is a diagram illustrating storing portions of a video signal in an internal memory of a timing controller and an external memory coupled to the timing controller, consistent with some embodiments.

FIG. 5 is a diagram illustrating storing portions of a video signal in a bridge circuit and an external memory coupled to the bridge circuit, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

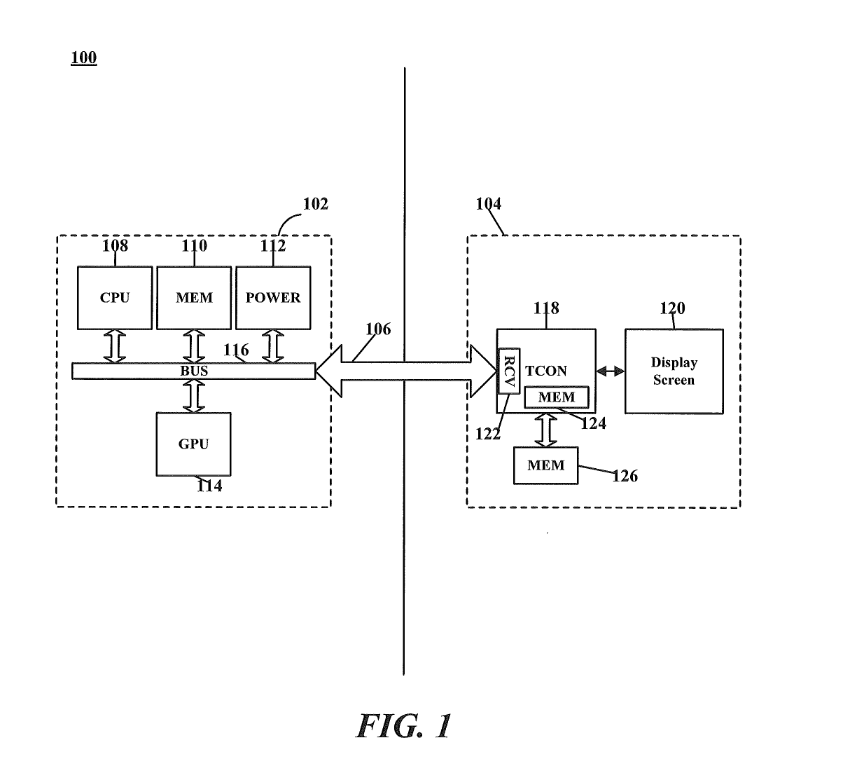

FIG. 1 is a diagram illustrating a display system, consistent with some embodiments. As shown in FIG. 1, system 100 includes a processing device 102 coupled to display device 104 via coupling 106. Processing device 102 may correspond to any electronic device including a processor and operable to output a video signal having video images for display on display device 104. Examples of processing device 102 include personal computers, laptop computers, smartphones, and tablet computers. Display device 104 may correspond to any device capable of receiving a video signal having one or more frames of a video image output from a processing device and displaying video images corresponding to the received video signals. Examples of display device 104 include a liquid crystal display (LCD) device, a plasma display device, an light emitting diode (LED) display device, or an organic LED (OLED) display device. Coupling 106 may correspond to any coupling configured to transmit video signals having video images from processing device 102 to display device 106. Coupling 106 may be a cable or a wireless coupling. Moreover, coupling 106 may be a coupling that conforms to one or more of the following transmission standards: Digital Visual Interface (DVI), High-Definition Multimedia Interface (HDMI), Video Graphics Array (VGA), and DisplayPort.

Returning to FIG. 1, processing device 102 includes a central processing unit (CPU) 108, a main memory 110, a power supply 112, and a graphics processing unit (GPU) 114 all coupled to a system bus 116. Display device 104 includes a timing controller (TCON) circuit 118 coupled to display screen 120. TCON circuit 118 includes receiving circuitry 122 for receiving video signals having frames of video images and internal memory 124. Consistent with some embodiments, TCON circuit 118 may also include external memory 126 coupled to TCON circuit 118. Further consistent with some embodiments, internal memory 124 may be of a different form or type of memory than external memory 126. For example, internal memory 124 may be static random access memory (SRAM), and external memory 126 may be a synchronous dynamic random access memory DRAM. In particular embodiments, internal memory 124 may be a single-transistor storage cell (1T) SRAM, and external memory 126 may be a mobile double data rate (DDR) synchronous DRAM. In some embodiments, external memory 126 may be stacked on a die of TCON circuit 122. Consistent with some embodiments, internal memory 124 may also have a higher bandwidth capability and a larger bit width than external memory 126, while external memory 126 has a larger storage capacity than internal memory 124. In such embodiments, video data may be written to and from internal memory 124 at a faster data rate than external memory 126 but more data may be written to external memory. Consistent with such embodiments, internal memory 204 may be configured to act as a cache for video signals transmitted from processing device 102 and GPU 114, internal memory 204 temporarily storing the video signal before off-loading the video signal to external memory 206 for storage. In order to conserve more power, GPU 114 may be designed to generate and transmit a video signal as quickly as possible and then enter a sleep state. The higher bandwidth of internal memory 204 allows for the temporary caching of the video signal before the entire transmitted signal can be written to external memory 206.

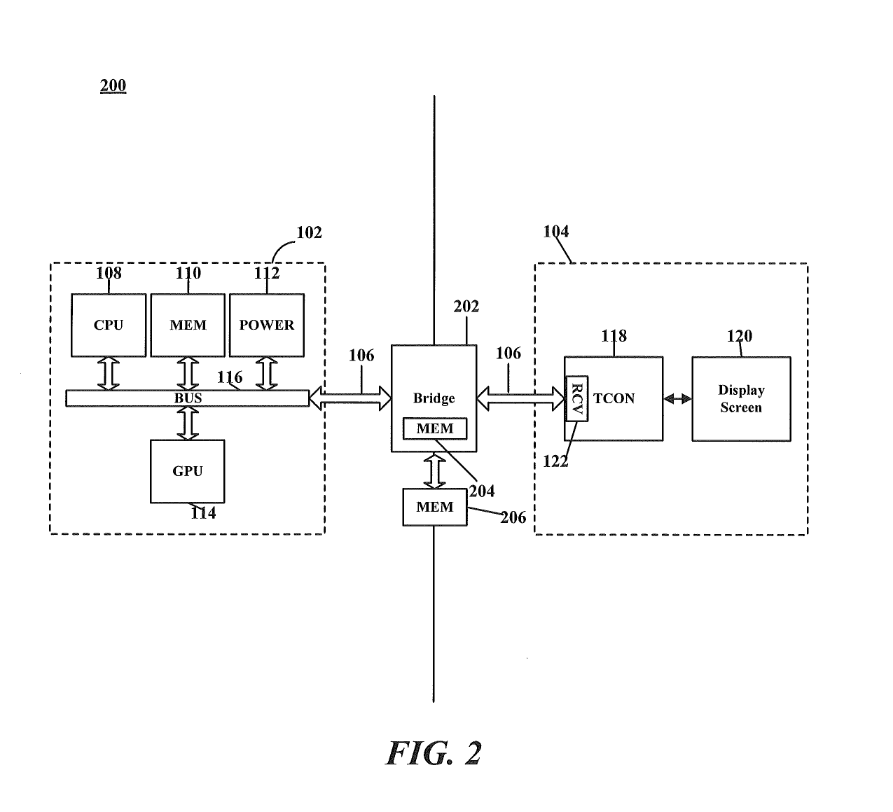

FIG. 2 is a diagram illustrating a display system consistent with some embodiments. Display system 200 is similar to system 100 and, thus, elements that are the same will not be described again here. The primary difference between display system 200 and display system 100 is that TCON circuit 118 does not include internal memory 124 and external memory 126. Typically, legacy TCON circuits do not have an internal memory or external memory and, thus, cannot be used to provide video buffering or refreshing. Consistent with some embodiments, a bridge circuit 202 provided along coupling 106 between processing device 102 and display device 104 may be used to provide video buffering or refreshing capabilities to systems with legacy TCON circuits. Bridge circuit 202 includes an internal memory 204 and an external memory 206. consistent with some embodiments, internal memory 204 may be of a different form or type of memory than external memory 206. For example, internal memory 204 may be static random access memory (SRAM), and external memory 206 may be a synchronous dynamic random access memory DRAM. In particular embodiments, internal memory 204 may be a single-transistor storage cell (1T) SRAM, and external memory 206 may be a mobile double data rate (DDR) synchronous DRAM. In some embodiments, external memory 206 may be stacked on a die of bridge circuit 202. Consistent with some embodiments, internal memory 204 may also have a higher bandwidth capability and a larger bit width than external memory 206, while external memory 206 has a larger storage capacity than internal memory 204. In such embodiments, video data may be written to and from internal memory 204 at a faster data rate than external memory 206 but more data may be written to external memory. Consistent with such embodiments, internal memory 204 may be configured to act as a cache for video signals transmitted from processing device 102 and GPU 114, internal memory 204 temporarily storing the video signal before off-loading the video signal to external memory 206 for storage. In order to conserve more power, GPU 114 may be designed to generate and transmit a video signal as quickly as possible and then enter a sleep state. The higher bandwidth of internal memory 204 allows for the temporary caching of the video signal before the entire transmitted signal can be written to external memory 206.

Consistent with some embodiments, bridge circuit 202 may be also utilized as a format conversion circuit. For example, bridge circuit may be utilized to convert a DisplayPort signal output from processing device 102 having GPU 114 to a DVI, HDMI, or VGA signal to input into a display device 104 that supports one of these standards but not DisplayPort. Alternatively the conversion could be between DVI to VGA, etc. In accordance with other embodiments, bridge circuit 202 may be used as an analog redriver to regenerate the video signal as it is transmitted between processing device 102 and display device 104.

The basic operation of systems 100 and 200 will be discussed in conjunction with FIGS. 1 and 2. Graphics processing unit (GPU) 114 receives instructions from CPU 108 and memory 110 over system bus 116 to compute rasterized frames of images. The frames (also referred to as images, pixel data, image data or, generally, video signal) are transferred to receiving circuitry 122 of TCON circuit 118 in bit blocks. The TCON circuit 118 then combines the bit blocks and transmits the combined bit blocks as a video signal to be displayed on display screen 120. In order to save on power consumption by GPU 114, GPU 114 may enter a sleep state. When GPU 114 enters a sleep state, memories external to GPU 114 may be used to store and render the last video signal transmitted from GPU 114. According to some embodiments, TCON circuit 118 may be configured to temporarily store at least a portion of video signal, such as one or more frames, output from GPU 114 in internal memory 124 while GPU is in a sleep state. Consistent with other embodiments, bridge circuit 202 may be configured to store at least a portion of video signal output from GPU 114 when GPU 114 is in a sleep state in internal memory 204 and another portion of the video signal in external memory 206. In particular, bridge circuit 202 may be configured to temporarily store or buffer at least a portion of a video signal, such as a frame, when TCON circuit 118 of display device 104 is not capable of temporarily storing at least a portion of a video signal, such as may be the case with older, legacy display devices having older TCON circuits. System 100 or 200 may utilize a power saving scheme referred to as Panel Self Refresh (PSR). PSR allows GPU 114 to enter a power saving, or “sleep” state, in between frame updates by temporarily storing, or buffering, the frames in a memory device. According to some embodiments, PSR requires that at least one frame of video data should be temporarily stored when GPU 114 enters a sleep state. In some embodiments, GPU 114 will output the video signal at a high data rate to TCON circuit 118 or bridge circuit 202, in particular at a higher rate than is required to output the video signal to display screen 120. This allows GPU 114 to quickly enter a sleep state while either bridge circuit 202 or TCON circuit 118 output the stored or buffered at a timing required by display screen 120. Further consistent with some embodiments, the timing required by display screen 120 may be replicated along coupling 106 by either TCON circuit 118 or bridge circuit 202. The memory device that is used to store the at least one frame may reside in the display controller or TCON circuit 118 of display device 104 or in bridge circuit 202. Consistent with some embodiments, TCON circuit 118 or bridge circuit 202 may be used to interface with display devices 104 having different requirements.

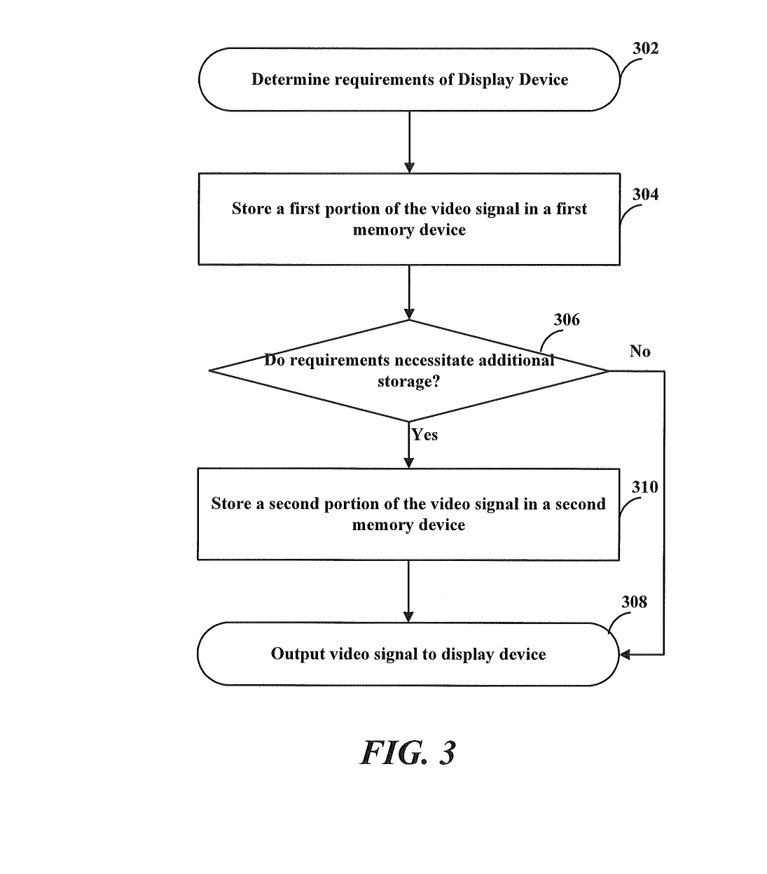

FIG. 3 is a flowchart illustrating a method for buffering a video signal generated by a graphics processing unit (GPU) for output to a display device, consistent with some embodiments. The method illustrated in FIG. 3 will be discussed with respect to system 100 in FIG. 1 and system 200 in FIG. 2 for illustration purposes. As shown in FIG. 1, the method begins by determining the requirements of display device 104 (302).—Consistent with some embodiments, the requirements may be determined by GPU 114 and communicated to TCON circuit 118 and/or bridge circuit 202. The requirements of display device 104 may include display requirements or capabilities, such as a display resolution, a color depth, and a refresh rate. For example, display requirements may require display device 104 to display video images from video signal in High Definition (HD), which requires display resolution of 1366 pixels by 768 pixels, at a color depth of 24 bits per pixel (bpp) at a refresh rate of 60 Hz. As another example, the display requirements may correspond to the Full High Definition (FHD) standard, requiring a display resolution of 1920 pixels by 1080 pixels, a color depth of 24 bpp and a refresh rate of 60 Hz.

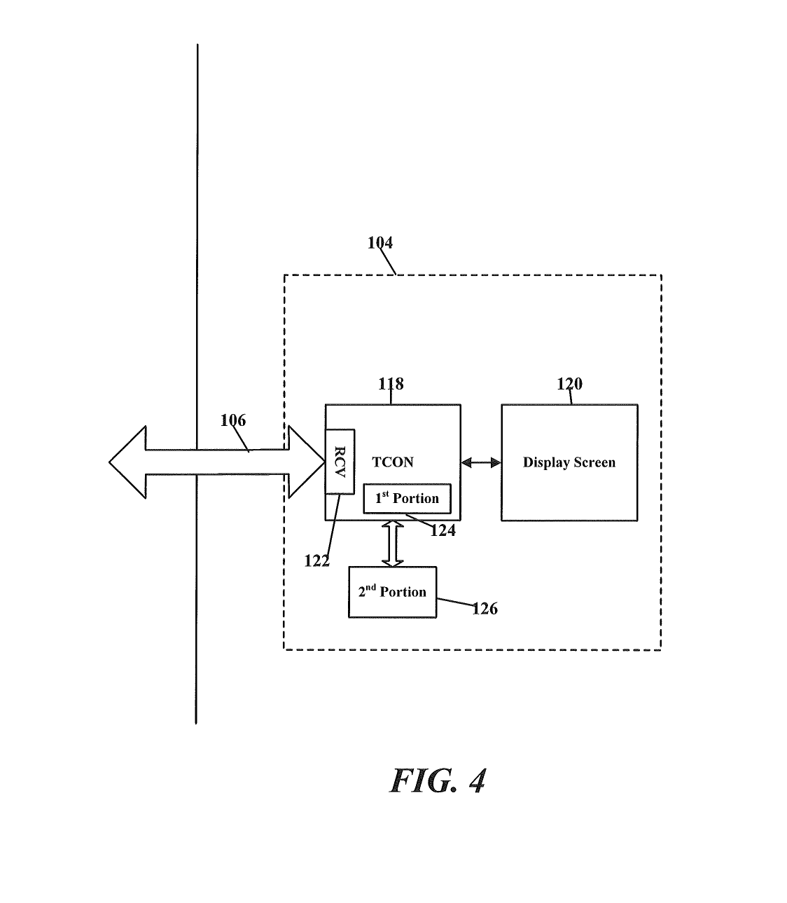

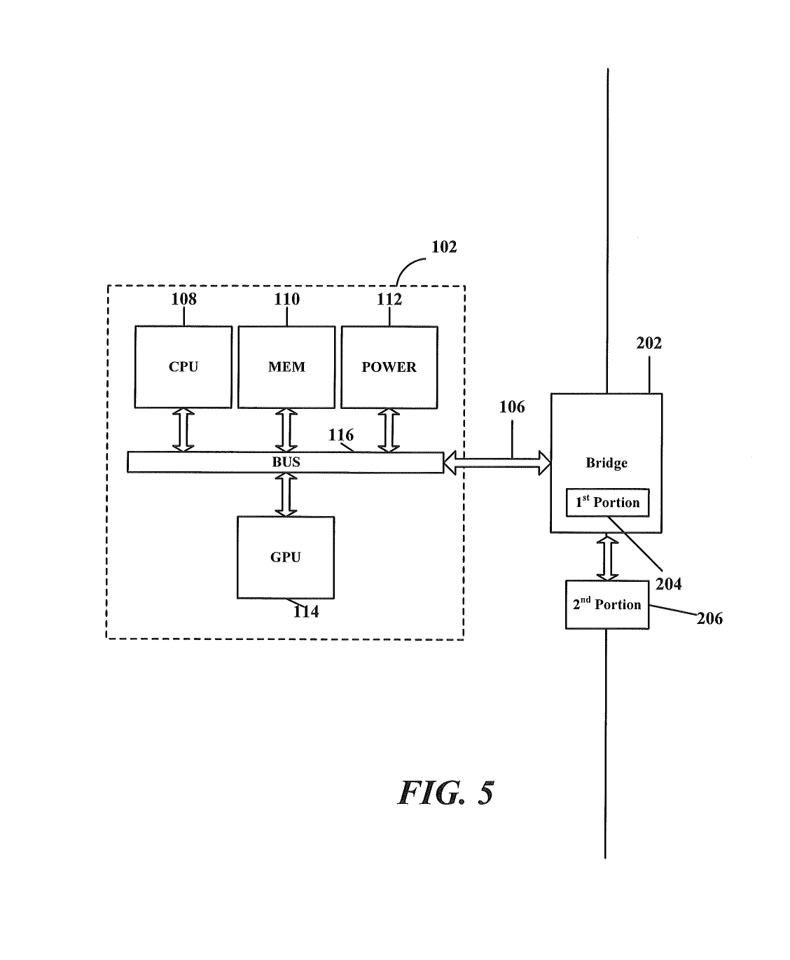

A first portion of the video signal is then stored in a first memory device (304). Consistent with some embodiments, first memory device may correspond to internal memory 124 of TCON circuit 118 (as shown in FIG. 4, below). Consistent with other embodiments, first memory device may correspond to internal memory 204 of bridge circuit 202 (as shown in FIG. 5, below). After the first portion of the video signal has been stored in the first memory device, a determination is made as to whether the requirements of display device 104 necessitate additional storage for the video signal (306). According to some embodiments, display devices having relatively low requirements may only require a single memory device for buffering the video signal. That is, due to the lower requirements, the entire frame may be buffered and stored in a single memory device. In such cases, none or zero percent of the video signal is stored in the second memory device, and the buffered video signal is output to display screen 120 based on a timing determined by TCON circuit 118 (308).

However, if the requirements of display device 104 necessitate additional storage in order to buffer the video signal, the video signal is split into a second portion, which is stored in a second memory device (310). Consistent with some embodiments, the second memory device may correspond to external memory 126 of TCON circuit 118 (as shown in FIG. 4, below). Consistent with other embodiments, the second memory device may correspond to external memory 206 of bridge circuit 202 (as shown in FIG. 5, below). Then, based on a timing determined by TCON circuit 122, the buffered first and/or first and second portions of the video signal are recombined by TCON circuit 118 and then output to display screen 120 (308). Consistent with some embodiments wherein a TCON circuit 118 does not have buffering capabilities, such as shown in FIG. 2, the buffered first and/or first and second portions of the video signal are recombined by bridge circuit 202 and then output to TCON circuit 118 before being displayed on display screen 120.

Further consistent with some embodiments, the second portion of the video signal may be encoded by TCON circuit 118 or bridge circuit 202 such that an encoded second portion is stored in a second memory device, such as external memory 126 or 206. Encoding the second portion may minimize transitions on the bus external to TCON circuit 118 or bridge circuit 202. The encoded second portion could then be decoded by TCON circuit 118 or bridge circuit 202 before the first and second portions are recombined and output to display screen 120. Consistent with some embodiments, the video signal received by TCON circuit 118 or bridge circuit 202 from GPU 114 could be compressed by TCON circuit or bridge circuit prior to splitting the signal into first and second portions. The compressed video signal would reduce both the memory and bandwidth requirements for storing a first compressed portion of the video signal in internal memory 124 or 204 and a second compressed portion of the video signal in external memory 126 or 206. The TCON circuit 118 or bridge circuit 202 then decompresses the compressed first and second portions of the video signal before outputting a recombined video signal to display device 120.

Consistent with some embodiments, splitting the video signal into first and second portions and saving the first and second portions in first and second memory devices provides flexibility for TCON circuitry 118, allowing TCON circuitry 118 to be used in display devices 104 having different display requirements. Moreover, by providing the second memory device to be external to TCON circuit 118, TCON circuit 118 can be flexible to differing requirements without increasing the on-die memory of TCON circuit 118 and, thus, the size of TCON circuit 118. For example, internal memory 124 of TCON circuit 118 can be designed to store enough of the video signal for a minimum display device 104 requirement and external memory 126 can be designed to store any portion of the video signal up to the maximum requirements of display device 104. In addition, additional memory can be added to external memory 126 as future requirements increase. In embodiments wherein TCON circuit 118 does not have buffering capabilities, such as shown in FIG. 2, internal memory 204 of bridge circuit 202 can be designed to store enough of the video signal for a minimum display device 104 requirement and external memory 206 can be designed to store any portion of the video signal up to the maximum requirements of display device 104. In addition, additional memory can be added to external memory 206 as future requirements increase. Although these embodiments describe splitting a video signal into two segments that are stored in two memories, additional embodiments may utilize more memories for storing additional portions of the video signal.

FIG. 4 is a diagram illustrating storing portions of a video signal in an internal memory of a timing controller and an external memory coupled to the timing controller, consistent with some embodiments. As shown in FIG. 4, a video signal may be split into a first portion and a second portion, with the first portion stored in an internal memory 124 of TCON circuit 118 and the second portion stored in an external memory 126 coupled to TCON circuit 118. Although the split portions of the video signal are referred to as being a “first portion” and a “second portion”, they may be referred to such portions interchangeably such that the first portion is stored in external memory 126 and the second portion is stored in internal memory 124. Consistent with some embodiments, the first portion of the video signal may correspond to data representing even-numbered pixels and the second portion of the video signal may correspond to data representing odd-numbered pixels. According to other embodiments, the first portion of the video signal may correspond to data representing a first half of an image-to-be-displayed and the second portion of the video signal may correspond to data representing a second half of an image-to-be-displayed. The first and second half may correspond to a right half or a left half. According further embodiments, the first portion may correspond to a maximum amount of the video signal that can be stored in internal memory 124 and the second portion is a remainder of the video signal. According to other embodiments, the first and second portion may be determined based on an available bandwidth and/or storage capacity of internal memory 124 and external memory 126.

In addition, the portion stored in external memory 126 may be zero percent of the video signal. That is, in some embodiments no portion of the video signal is stored in external memory 126. In such embodiments, the requirements of display device 104 are low enough such that all of the video signal can be stored in internal memory 124. When no portion of the video signal is stored in external memory 126, external memory 126 does not consume any power to provide additional power savings.

FIG. 5 is a diagram illustrating storing portions of a video signal in a bridge circuit and an external memory coupled to the bridge circuit, consistent with some embodiments. As shown in FIG. 5, a video signal may be split into a first portion and a second portion, with the first portion stored in an internal memory 204 of bridge circuit 202 and the second portion stored in external memory 206 of bridge circuit 202. Although the split portions of the video signal are referred to as being a “first portion” and a “second portion”, they may be referred to interchangeable such that the first portion is stored in external memory 206 and the second portion is stored in bridge circuit 202. Consistent with some embodiments, the first portion of the video signal may correspond to data representing even-numbered pixels and the second portion of the video signal may correspond to data representing odd-numbered pixels. According to other embodiments, the first portion of the video signal may correspond to data representing a first half of an image-to-be-displayed and the second portion of the video signal may correspond to data representing a second half of an image-to-be-displayed. The first and second half may correspond to a right half or a left half. According to further embodiments, the first portion may correspond to a maximum amount of the video signal that can be stored in internal memory 204 of bridge circuit 202 and the second portion is a remainder of the video signal. According to other embodiments, the first and second portion may be determined based on an available bandwidth and/or storage capacity of internal memory 124 and external memory 126. Consistent with some embodiments, bridge circuit 202 may be configured to act as an analog redriver to regenerate the video signals from GPU 114 when GPU 114 is not in a sleep state or power saving mode in order to further minimize power consumption.

In addition, the portion stored in external memory 206 may be zero percent, i.e., no portion of the video signal is stored in external memory 206 because the requirements of display device 104 are low enough such that all of the video signal can be stored in internal memory 204. When no portion of the video signal is stored in external memory 206, external memory 206 does not consume any power to provide additional power savings.

Consistent with embodiments described herein, a system and method are provided that split the video signal into first and second portions and store the first and second portions in first and second memory devices to provide power savings for a system by allowing the GPU to enter a sleep state between frame rates while still providing flexibility for TCON circuitry allowing TCON circuitry to be used in display devices having different display requirements. Moreover, by providing the second memory device to be external to TCON circuit, TCON circuit can be flexible to differing requirements without increasing the memory on TCON circuit and, thus, the size of TCON circuit. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A circuit for buffering a video signal, comprising:
circuitry for receiving the video signal for output to a display device;
a first memory device for receiving a first portion of the video signal; and
a second memory device for receiving a second portion of the video signal, wherein
the first portion and the second portion are determined by requirements of the display device.

2. The circuit of claim 1, wherein the second portion is zero percent of the video signal.

3. The circuit of claim 2, wherein the second memory consumes no power when the second portion is zero percent of the video signal.

4. The circuit of claim 1, wherein the first portion is determined based on an available bandwidth of the first memory device and the second portion is determined based on an available bandwidth of the second memory device.

5. The circuit of claim 1, wherein the first portion is determined based on an available storage capacity of the first memory device and the second portion is determined based on an available storage capacity of the second memory device.

6. The circuit of claim 1, further comprising:
an integrated circuit, the controller, circuitry and the first memory device all being located on the integrated circuit, wherein
the second memory device is located on the integrated circuit and external to the controller.

7. The circuit of claim 1, wherein the circuit comprises a timing controller circuit located in the display device, the first memory device comprising an internal memory of the timing controller circuit, and the second memory device comprising an external memory coupled to the timing controller circuit.

8. The circuit of claim 1, wherein the circuit comprises a bridge circuit located between the display device and a graphics processing unit (GPU) generating the video signal, the first memory device comprising an internal memory of the bridge circuit, and the second memory device comprising an external memory coupled to the bridge circuit.

9. The circuit of claim 1, wherein the first memory device comprises a different type of memory than the second memory device.

10. The circuit of claim 9, wherein the first memory device has a greater bandwidth than the second memory device and the second memory device has a greater storage capacity than the first memory device.

11. The circuit of claim 10, wherein the first memory device is configured to act as a cache for the second memory device, the first portion corresponding to portions of the video signal temporarily stored in the first memory device, and the second portion corresponding to portions of the video signal that have been transferred from the first memory device.

12. The circuit of claim 1, wherein the second portion received by the second memory device is encoded.

13. The circuit of claim 1, wherein the first portion and the second portion are compressed.

14. A system for buffering a video signal, comprising:
a graphics processing unit (GPU), the GPU generating the video signal;
a buffering circuit coupled to the GPU, the buffering circuit receiving and temporarily storing the video signal when the GPU enters a power-saving mode; and
a display device coupled to the bridge circuit and receiving the video signal from the buffering circuit, wherein
the buffering circuit comprises:
an internal memory device configured to temporarily store a first portion of the video signal; and
an external memory device configured to temporarily store a second portion of the video signal.

15. The system of claim 14, wherein the buffering circuit comprises a bridge circuit, the bridge circuit arranged between the GPU and the display device and being configured to regenerate the video signal when the GPU is not in a power-saving mode.

16. The system of claim 14, wherein the buffering circuit comprises a timing controller (TCON) located in the display device.

17. The system of claim 14, wherein the first portion and the second portion are determined based on requirements of the display device.

18. The system of claim 14, wherein the second portion is zero percent of the video signal and the external memory consumes no power.

19. The system of claim 14, wherein the first portion is determined based on at least one of an available bandwidth and an available storage capacity of the internal memory device and the second portion is determined based on at least one of an available bandwidth and an available storage capacity of the external memory device.

20. The circuit of claim 14, wherein the second portion of the video signal temporarily stored by the external memory device is encoded.

21. The circuit of claim 14, wherein the first portion of the video signal and the second portion of the video signal are compressed.

22. A method for buffering a video signal generated by a graphics processing unit (GPU) for output to a display device, comprising:
determining requirements of the display device; and
selectively storing portions of the video signal in a first memory device and a second memory device based on the determined requirements.

23. The method of claim 22, wherein the first memory device comprises an internal memory of a timing controller circuit and the second memory comprises a memory external and coupled to the timing controller circuit.

24. The method of claim 22, wherein the first memory device comprises an internal memory of a bridge circuit and the second memory comprises a memory external and coupled to the bridge circuit.

25. The method of claim 22, wherein selectively storing portions of the video signal comprises:
selectively storing a first portion of the video signal in the first memory device; and
selectively storing a second portion of the video signal in the second memory device.

26. The method of claim 25, further comprising:
determining the first portion based on at least one of a bandwidth and a storage capability of the first memory device; and
determining the second portion based on at least one of a bandwidth and a storage capability of the second memory device.

27. The method of claim 25, wherein selectively storing a second portion of the video signal comprises:
encoding the second portion of the video signal; and
storing the encoded second portion in the second memory device.

28. The method of claim 25, wherein:
selectively storing a first portion of the video signal comprises compressing the first portion of the video signal and storing the compressed first portion in the first memory device; and
selectively storing a second portion of the video signal comprises compressing the second portion of the video signal and storing the compressed second portion in the second memory device.

29. The method of claim 22, wherein selectively storing portions of the video signal in a first memory device and a second memory device comprises storing portions of the video signal in different memory types.
